(19) United States
(12) Patent Application Publication
(10) Pub. No.: US 2025/0280465 A1
(43) Pub. Date: Sep. 4, 2025

(54) WIRELESS SIGNAL TRANSMISSION/RECEPTION METHOD AND DEVICE IN WIRELESS COMMUNICATION SYSTEM

(71) Applicant: LG Electronics Inc., Seoul (KR)

(72) Inventors: Seunggye HWANG, Seoul (KR); Youngdae LEE, Seoul (KR); Jaehyung KIM, Seoul (KR)

(21) Appl. No.: 18/859,032

(22) PCT Filed: Mar. 30, 2023
(86) PCT No.: PCT/KR2023/004226

§ 371 Date: Oct. 22, 2024

(30) Foreign Application Priority Data
Apr. 28, 2022 (KR) 10-2022-0052990

(51) Int. Cl. H04W 76/27

(52) U.S. Cl. CPC H04W 76/27

(57) ABSTRACT

A terminal according to at least one from among embodiments disclosed in the present specification receives discontinuous reception (DRX) configuration information about a plurality of cells including at least one first cell and at least one second cell through upper layer signaling, and monitors a physical downlink control channel (PDCCH) in at least one of the plurality of cells on the basis of the DRX configuration information, wherein the DRX configuration information includes information about on-duration that is set in each of the plurality of cells, and on-duration that is set in the second cell from among the plurality of cells can start, on the basis of the DRX configuration information, in a dormancy state in which the monitoring for the PDCCH is not performed.

### TECHNICAL FIELD

The disclosure relates to a wireless communication system, and more particularly, to a method and apparatus for transmitting and receiving a wireless signal.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may be any of a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

### DISCLOSURE

### Technical Problem

An object of the disclosure is to provide a method of efficiently performing wireless signal transmission/reception procedures and an apparatus therefor.

It will be appreciated by persons skilled in the art that the objects that could be achieved with the disclosure are not limited to what has been particularly described hereinabove and the above and other objects that the disclosure could achieve will be more clearly understood from the following detailed description.

### Technical Solution

According to an aspect of the disclosure, a method of receiving a signal by a user equipment (UE) in a wireless communication system may include receiving discontinuous reception (DRX) configuration information for a plurality of cells including at least one first cell and at least one second cell through higher layer signaling, and monitoring a physical downlink control channel (PDCCH) in at least one of the plurality of cells based on the DRX configuration information. The DRX configuration information may include information about an On-duration configured in each of the plurality of cells. An On-duration configured in the at least one second cell among the plurality of cells may start with a dormancy state in which the PDCCH is not monitored based on the DRX configuration information.

The DRX configuration information may indicate to configure an On-duration starting with the dormancy state in remaining cells excluding the at least one first cell among the plurality of cells.

The DRX configuration information may include information indicating cells configured with an On-duration starting with the dormancy state.

Upon a timer expires, monitoring of the PDCCH may be started in the On-duration configured in the at least one second cell.

The dormancy state may be maintained in the at least one second cell until a specific signal is received in the at least one first cell.

The information about the On-duration may include information about an offset from a start of a DRX cycle to an On-duration start. The information about the offset may be indicated for each cell or commonly for cells belonging to the same DRX group.

The On-duration configured in the at least one second cell may start after starting an On-duration configured in the at least one first cell.

The DRX configuration information may be configured for data having a non-integer periodicity.

According to another aspect of the disclosure, a UE performing the above signal reception method may be provided.

According to another aspect of the disclosure, a processor-readable recording medium recording a program for performing the above signal reception method may be provided.

According to another aspect of the disclosure, a device for controlling a UE that performs the above signal reception method may be provided.

According to another aspect of the disclosure, a method of transmitting a signal by a base station (BS) in a wireless communication system may include transmitting DRX configuration information for a plurality of cells including at least one first cell and at least one second cell to a UE through higher layer signaling, and transmitting a PDCCH to the UE in at least one of the plurality of cells based on the DRX configuration information. The DRX configuration information may include information about an On-duration configured in each of the plurality of cells. An On-duration configured in the at least one second cell among the plurality of cells may start with a dormancy state in which the PDCCH is not monitored based on the DRX configuration information.

According to another aspect of the disclosure, a BS performing the above signal transmission method may be provided.

### Advantageous Effects

According to an embodiment of the disclosure, a signal transmission/reception may be performed through an improved DRX operation for a plurality of cells, thereby increasing power efficiency.

It will be appreciated by persons skilled in the art that the effects that can be achieved with the disclosure are not limited to what has been particularly described hereinabove and other advantages of the disclosure will be more clearly understood from the following detailed description taken in conjunction with the accompanying drawings.

### BRIEF DESCRIPTION OF THE DRAWINGS

FIG. 1 illustrates physical channels used in a 3rd generation partnership project (3GPP) system as an exemplary wireless communication system, and a general signal transmission method using the same.

FIG. 2 illustrates a radio frame structure.

FIG. 3 illustrates a resource grid of a slot.

FIG. 4 illustrates exemplary mapping of physical channels in a slot. FIG. 1 illustrates physical channels used in a 3rd generation partnership project (3GPP) system as an exemplary wireless communication system, and a general signal transmission method using the same.

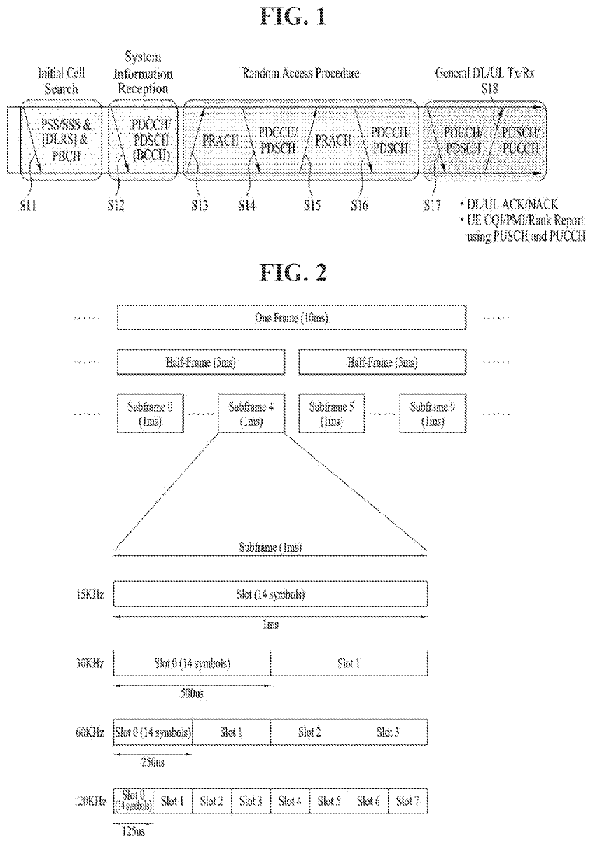

FIG. 2 illustrates a radio frame structure.

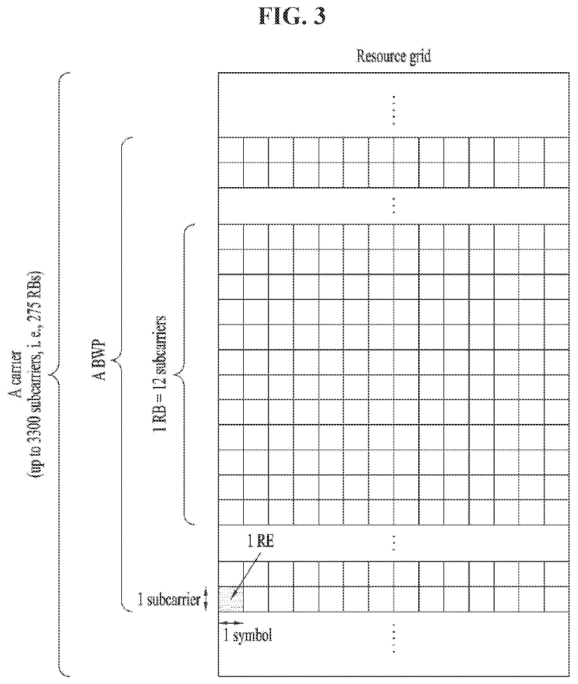

FIG. 3 illustrates a resource grid of a slot.

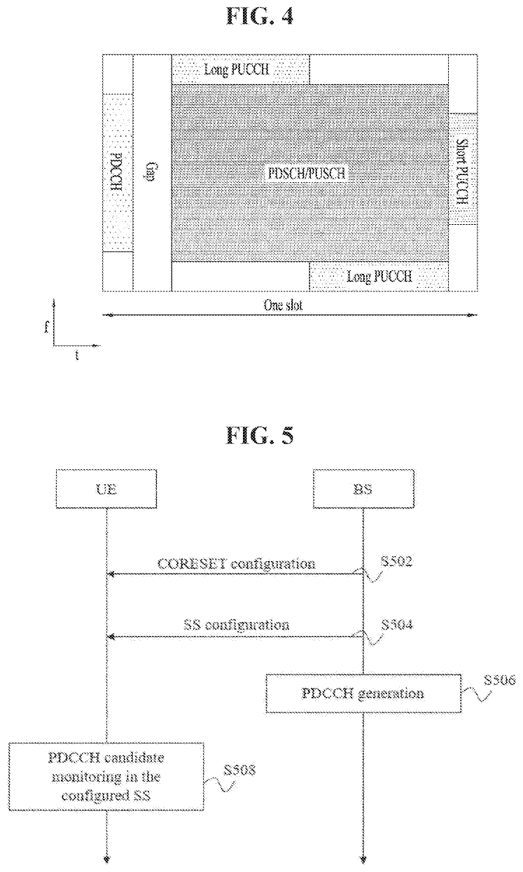

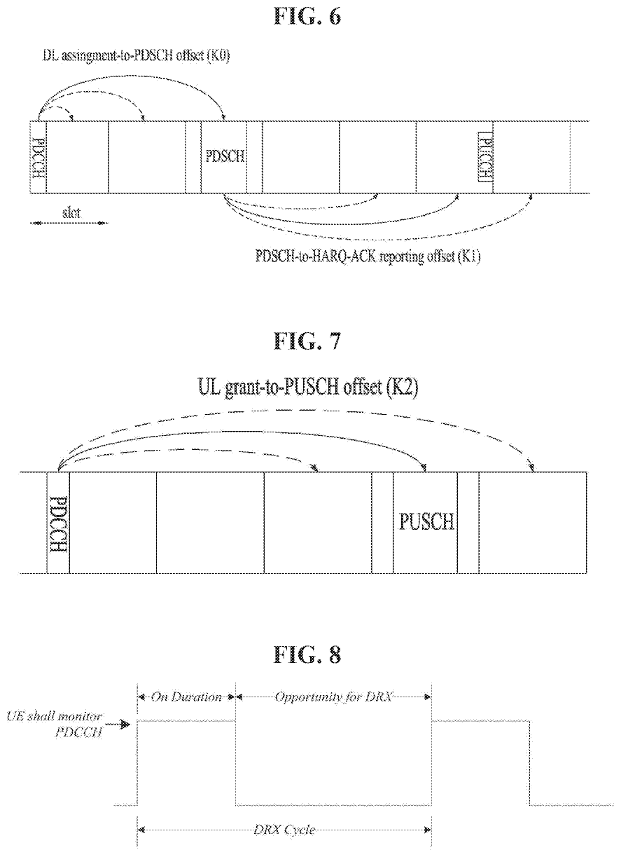

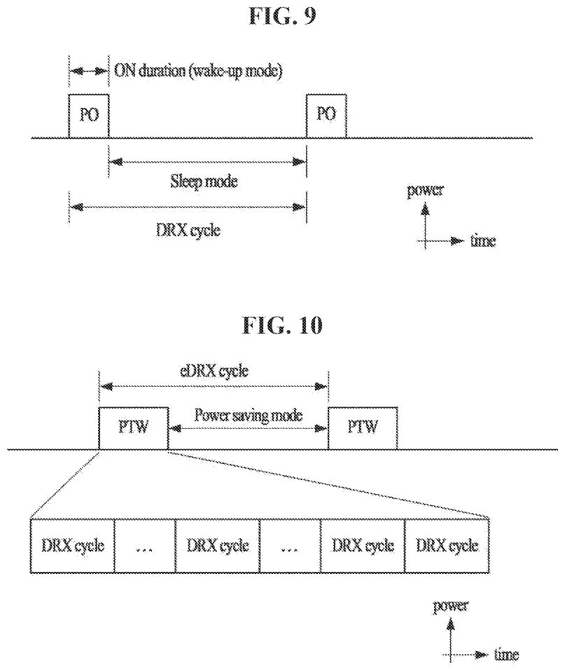

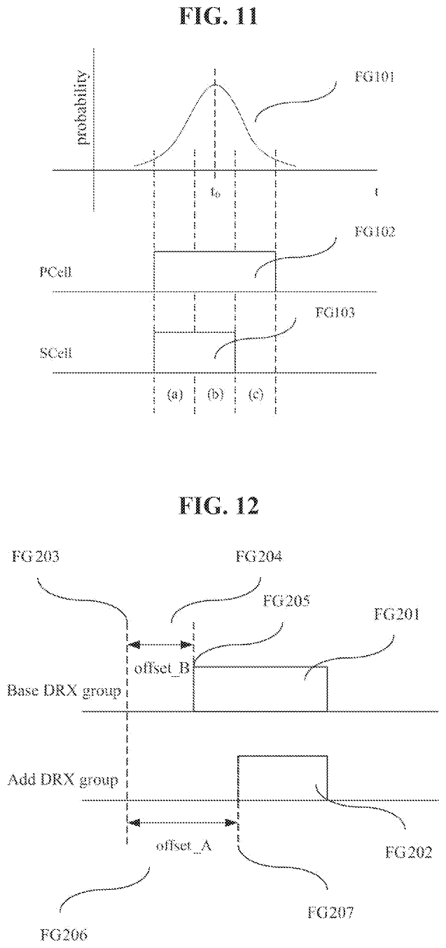

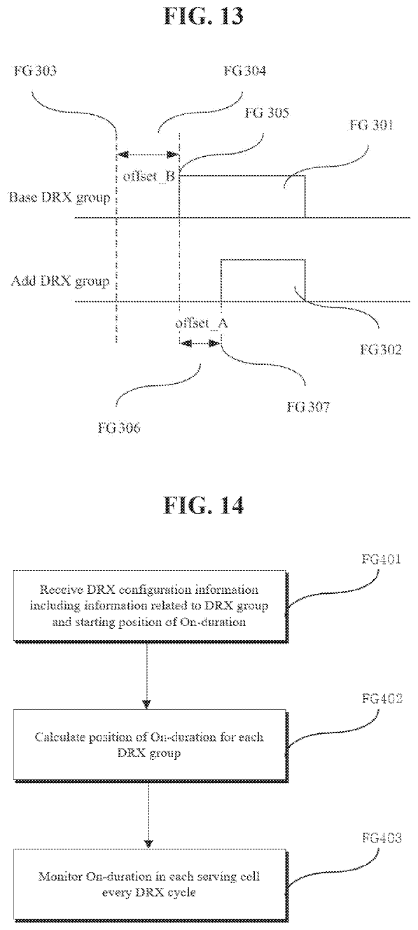

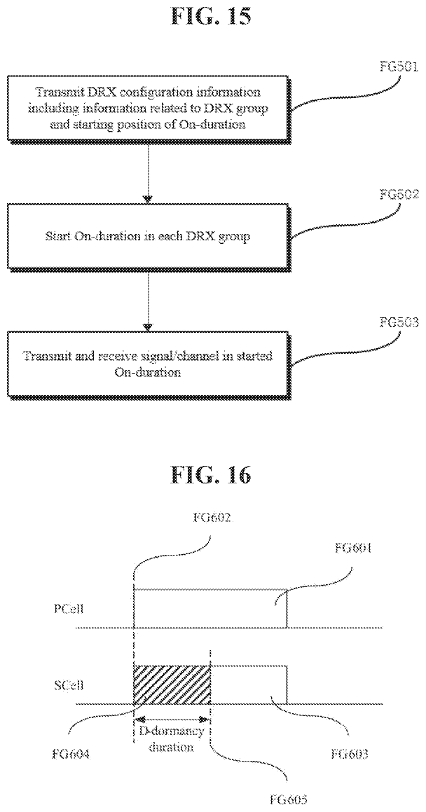

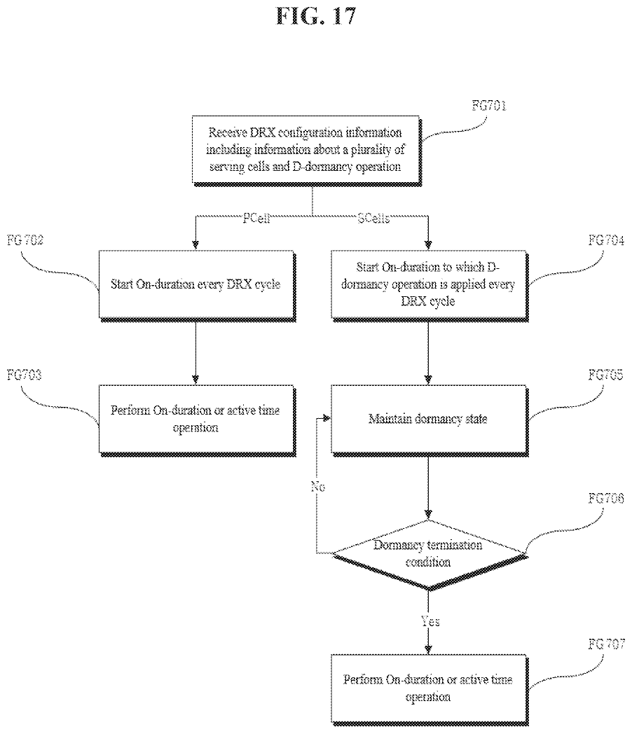

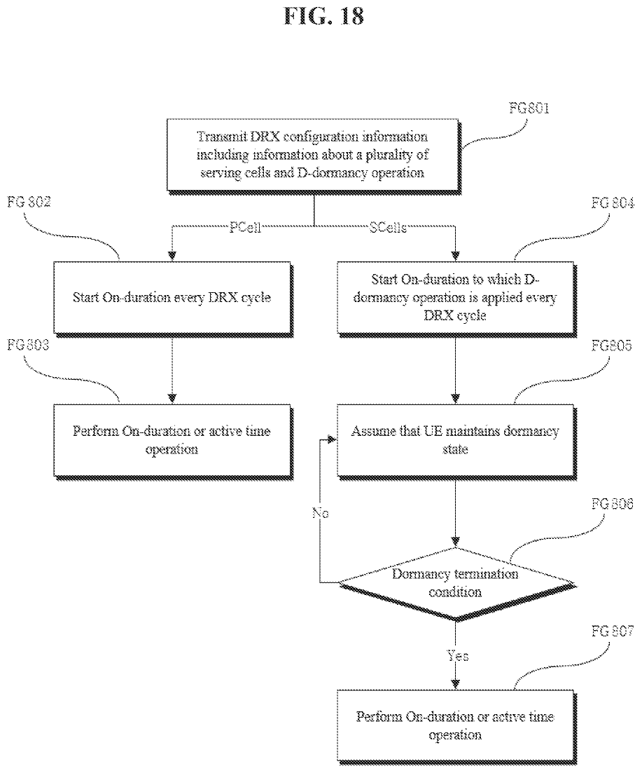

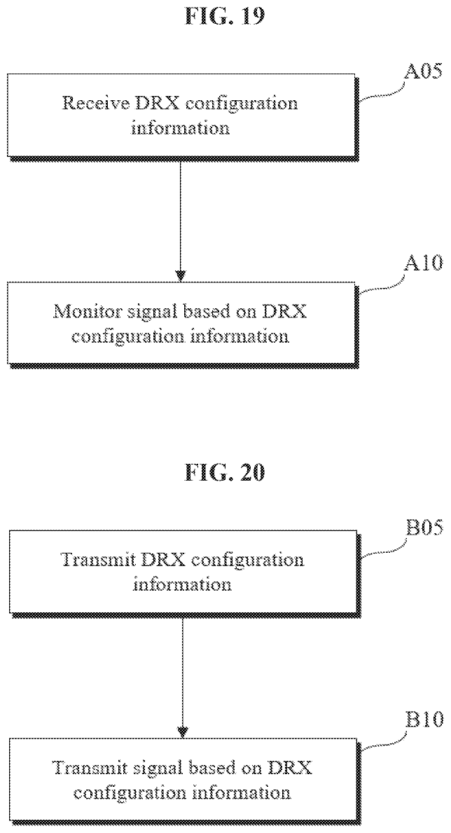

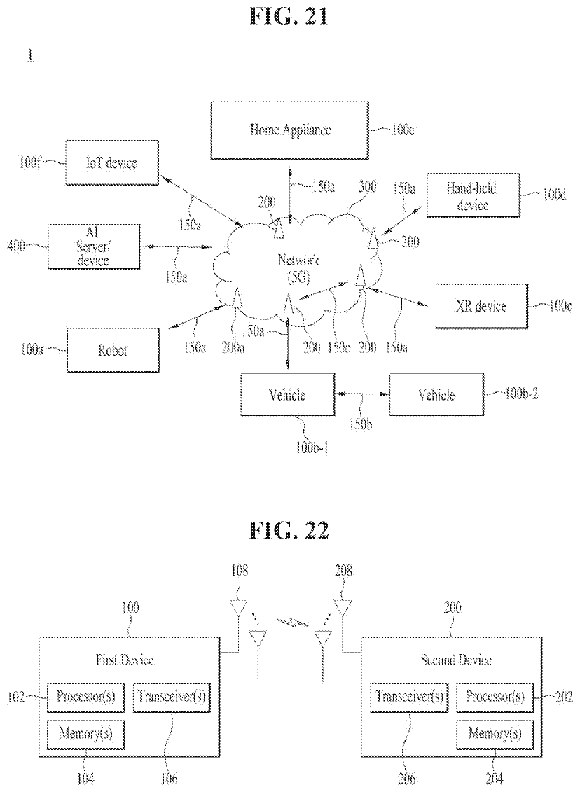

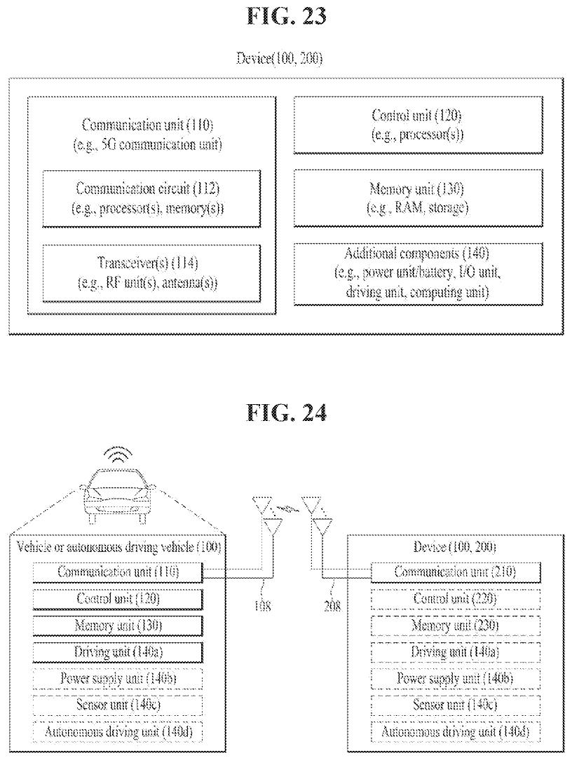

FIG. 4 illustrates exemplary mapping of physical channels in a slot.

FIG. 5 illustrates an exemplary physical downlink control channel (PDCCH) transmission and reception process.

FIG. 6 illustrates an exemplary physical downlink shared channel (PDSCH) reception and acknowledgement/negative acknowledgement (ACK/NACK) transmission process.

FIG. 7 illustrates an exemplary physical uplink shared channel (PUSCH) transmission process.

FIGS. 8 to 10 are diagrams for explaining discontinuous reception (DRX) related operations.

FIG. 11 illustrates an example of traffic generation in each cell in a carrier aggregation situation.

FIGS. 12 and 13 illustrate On-duration configurations for a DRX operation, respectively.

FIG. 14 illustrates an exemplary user equipment (UE) operation.

FIG. 15 illustrates an exemplary base station (BS) operation.

FIG. 16 illustrates an exemplary dormancy configuration for an On-duration for a DRX operation.

FIG. 17 illustrates an exemplary UE operation.

FIG. 18 illustrates an exemplary BS operation.

FIG. 19 is a flowchart illustrating a signal reception method of a UE according to an embodiment.

FIG. 20 is a flowchart illustrating a signal transmission method of a BS according to an embodiment.

FIG. 21 to FIG. 24 illustrate an example of a communication system 1 and wireless devices applicable to the disclosure.

### DETAILED DESCRIPTION

Embodiments of the disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In an embodiment of the disclosure, for simplicity, this technology will be referred to as NR (New Radio or New RAT).

For the sake of clarity, 3GPP NR is mainly described, but the technical idea of the disclosure is not limited thereto.

For the background art relevant to the disclosure, the definitions of terms, and abbreviations, the following documents may be incorporated by reference.

### 3GPP LTE

TS 36.211: Physical channels and modulation
TS 36.212: Multiplexing and channel coding
TS 36.213: Physical layer procedures
TS 36.300: Overall description
TS 36.321: Medium Access Control (MAC)
TS 36.331: Radio Resource Control (RRC)

### 3GPP NR

TS 38.211: Physical channels and modulation
TS 38.212: Multiplexing and channel coding
TS 38.213: Physical layer procedures for control
TS 38.214: Physical layer procedures for data
TS 38.300: NR and NG-RAN Overall Description
TS 38.304: User Equipment (UE) procedures in idle mode and in RRC Inactive state
TS 38.321: Medium Access Control (MAC)
TS 38.331: Radio Resource Control (RRC) protocol specification
TS 37.213: Introduction of channel access procedures to unlicensed spectrum for NR-based access

### Terms and Abbreviations

PSS: Primary Synchronization Signal
SSS: Secondary Synchronization Signal
CRS: Cell reference signal
CSI-RS: Channel State Information Reference Signal
TRS: Tracking Reference Signal
SS: Search Space
CSS: Common Search Space
USS: UE-specific Search Space
PDCCH: Physical Downlink Control Channel; The PDCCH is used to represent PDCCHs of various structures which may be used for the same purpose in the following description.
PO: Paging Occasion
MO: Monitoring Occasion
SI: System Information
PEI: Paging Early Indication
DRX: Discontinuous Reception
eDRX: Extended DRX
PCell: Primary Cell
SCell: Secondary Cell
PSCell: Primary SCG (Secondary Cell Group) Cell
CA: Carrier Aggregation

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

N^{slot}_{symb}: Number of symbols in a slot
N^{frame,u}ₛₗₒₜ: Number of slots in a frame
N^{subframe,u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

FIG. 4 illustrates an example of mapping physical channels in a slot. In an NR system, a frame is characterized by a self-contained structure in which all of a DL control channel, DL or UL data, and a UL channel may be included in one slot. For example, the first N symbols of a slot may be used to carry a DL channel (e.g., PDCCH) (hereinafter, referred to as a DL control region), and the last M symbols of the slot may be used to carry a UL channel (e.g., PUCCH) (hereinafter, referred to as a UL control region). Each of N and M is an integer equal to or larger than 0. A resource area (hereinafter, referred to as a data region) between the DL control region and the UL control region may be used to transmit DL data (e.g., PDSCH) or UL data (e.g., PUSCH). A guard period (GP) provides a time gap for switching from a transmission mode to a reception mode or from the reception mode to the transmission mode. Some symbols at a DL-to-UL switching time in a subframe may be configured as a GP.

The PDCCH delivers DCI. For example, the PDCCH (i.e., DCI) may carry information about a transport format and resource allocation of a DL shared channel (DL-SCH), resource allocation information of an uplink shared channel (UL-SCH), paging information on a paging channel (PCH), system information on the DL-SCH, information on resource allocation of a higher-layer control message such as an RAR transmitted on a PDSCH, a transmit power control command, information about activation/release of configured scheduling, and so on. The DCI includes a cyclic redundancy check (CRC). The CRC is masked with various identifiers (IDs) (e.g., a radio network temporary identifier (RNTI)) according to an owner or usage of the PDCCH. For example, if the PDCCH is for a specific UE, the CRC is masked by a UE ID (e.g., cell-RNTI (C-RNTI)). If the PDCCH is for a paging message, the CRC is masked by a paging-RNTI (P-RNTI). If the PDCCH is for system information (e.g., a system information block (SIB)), the CRC is masked by a system information RNTI (SI-RNTI). When the PDCCH is for an RAR, the CRC is masked by a random access-RNTI (RA-RNTI).

FIG. 5 illustrates an exemplary PDCCH transmission/reception process.

Referring to FIG. 5, a BS may transmit a control resource set (CORESET) configuration to a UE (S502). A CORESET is defined as a resource element group (REG) set having a given numerology (e.g., a subcarrier spacing (SCS), a cyclic prefix (CP) length, and so on). An REG is defined as one OFDM symbol by one (physical) resource block (P) RB. A plurality of CORESETs for one UE may overlap with each other in the time/frequency domain. A CORESET may be configured by system information (e.g., a master information block (MIB)) or higher-layer signaling (e.g., radio resource control (RRC) signaling). For example, configuration information about a specific common CORESET (e.g., CORESET #0) may be transmitted in the MIB. For example, a PDSCH carrying system information block 1 (SIB1) may be scheduled by a specific PDCCH, and CORESET #0 may be used to transmit the specific PDCCH. System information (SIB1) broadcast in a cell includes cell-specific PDSCH configuration information, PDSCH-ConfigCommon. PDSCH-ConfigCommon includes a list (or look-up table) of parameters related to a time-domain resource allocation, pdsch-TimeDomainAllocationList. Each pdsch-TimeDomain AllocationList may include up to 16 entries (or rows) each being joint-encoded {K0, PDSCH mapping type, PDSCH start symbol and length (SLIV)}. Aside from (additionally to) pdsch-TimeDomainAllocationList configured through PDSCH-ConfigCommon, pdsch-TimeDomain AllocationList may be provided through a UE-specific PDSCH configuration, PDSCH-Config, pdsch-TimeDomainAllocationList configured UE-specifically has the same structure as pdsch-TimeDomain AllocationList provided UE-commonly. For K0 and an SLIV of pdsch-TimeDomainAllocationList, the following description is referred to.

Further, configuration information about CORESET #N (e.g., N>0) may be transmitted by RRC signaling (e.g., cell-common RRC signaling, UE-specific RRC signaling, or the like). For example, the UE-specific RRC signaling carrying CORESET configuration information may include, but not limited to, various types of signaling such as an RRC setup message, an RRC reconfiguration message, and/or BWP configuration information. Specifically, a CORESET configuration may include the following information/fields.
controlResourceSetId: Indicates the ID of a CORESET.
frequency DomainResources: Indicates the frequency-domain resources of the CORESET. The resources are indicated by a bitmap in which each bit corresponds to an RB group (=6 (consecutive) RBs). For example, the most significant bit (MSB) of the bitmap corresponds to a first RB group in a BWP. An RB group corresponding to a bit having a bit value of 1 is allocated as frequency-domain resources of the CORESET.
duration: Indicates the time-domain resources of the CORESET. It indicates the number of consecutive OFDM symbols included in the CORESET. The duration has a value between 1 and 3.
cce-REG-MappingType: Indicates a control channel element (CCE)-to-REG mapping type. An interleaved type and a non-interleaved type are supported.
interleaverSize: Indicates an interleaver size.
pdcch-DMRS-ScramblingID: Indicates a value used for PDCCH DMRS initialization. When pdcch-DMRS-ScramblingID is not included, the physical cell ID of a serving cell is used.
precoderGranularity: Indicates a precoder granularity in the frequency domain.
reg-BundleSize: Indicates an REG bundle size.
tci-PresentInDCI: Indicates whether a transmission configuration index (TCI) field is included in DL-related DCI.
tci-StatesPDCCH-ToAddList: Indicates a subset of TCI states configured in pdcch-Config, used for providing quasi-co-location (QCL) relationships between DL RS(s) in an RS set (TCI-State) and PDCCH DMRS ports.

Further, the BS may transmit a PDCCH search space (SS) configuration to the UE (S504). The PDCCH SS configuration may be transmitted by higher layer signaling (e.g., RRC signaling). For example, the RRC signaling may include, but not limited to, various types of signaling such as an RRC setup message, an RRC reconfiguration message, and/or BWP configuration information. While a CORESET configuration and a PDCCH SS configuration are shown as separately signaled in FIG. 5, for convenience of description, the disclosure is not limited thereto. For example, the CORESET configuration and the PDCCH SS configuration may be transmitted in one message (e.g., by one RRC signaling) or separately in different messages.

The PDCCH SS configuration may include information about the configuration of a PDCCH SS set. The PDCCH SS set may be defined as a set of PDCCH candidates monitored (e.g., blind-detected) by the UE. One or more SS sets may be configured for the UE. Each SS set may be a UE-specific search space (USS) set or a common search space (CSS) set. For convenience, PDCCH SS set may be referred to as “SS” or “PDCCH SS.”

A PDCCH SS set includes PDCCH candidates. A PDCCH candidate is CCE(s) that the UE monitors to receive/detect a PDCCH. The monitoring includes blind decoding (BD) of PDCCH candidates. One PDCCH (candidate) includes 1, 2, 4, 8, or 16 CCEs according to an aggregation level (AL). One CCE includes 6 REGs. Each CORESET configuration is associated with one or more SSs, and each SS is associated with one CORESET configuration. One SS is defined based on one SS configuration, and the SS configuration may include the following information/fields.
searchSpaceId: Indicates the ID of an SS.
controlResourceSetId: Indicates a CORESET associated with the SS.
monitoringSlotPeriodicity AndOffset: Indicates a periodicity (in slots) and offset (in slots) for PDCCH monitoring.
monitoringSymbolsWithinSlot: Indicates the first OFDM symbol(s) for PDCCH monitoring in a slot configured with PDCCH monitoring. The first OFDM symbol(s) for PDCCH monitoring is indicated by a bitmap with each bit corresponding to an OFDM symbol in the slot. The MSB of the bitmap corresponds to the first OFDM symbol of the slot. OFDM symbol(s) corresponding to bit(s) set to 1 corresponds to the first symbol(s) of a CORESET in the slot.
nrofCandidates: Indicates the number of PDCCH candidates (one of values 0, 1, 2, 3, 4, 5, 6, and 8) for each AL where AL={1, 2, 4, 8, 16}.
searchSpaceType: Indicates CSS or USS as well as a DCI format used in the corresponding SS type.

Subsequently, the BS may generate a PDCCH and transmit the PDCCH to the UE (S506), and the UE may monitor PDCCH candidates in one or more SSs to receive/detect the PDCCH (S508). An occasion (e.g., time/frequency resources) in which the UE is to monitor PDCCH candidates is defined as a PDCCH (monitoring) occasion. One or more PDCCH (monitoring) occasions may be configured in a slot.

Table 3 shows the characteristics of each SS.

TABLE 3

| | Search | | |
|---|---|---|---|
| Type | Space | RNTI | Use Case |
| Type0- | Common | SI-RNTI on a primary cell | SIB Decoding |
| PDCCH | | | |
| Type0A- | Common | SI-RNTI on a primary cell | SIB Decoding |
| PDCCH | | | |
| Typel- | Common | RA-RNTI or TC-RNTI on a primary | Msg2, Msg4 |
| PDCCH | | cell | decoding in |
| | | | RACH |
| Type2- | Common | P-RNTI on a primary cell | Paging Decoding |
| PDCCH | | | |
| Type3- | Common | INT-RNTI, SFI-RNTI, TPC- | |
| PDCCH | | PUSCH-RNTI, TPC-PUCCH-RNTI, | |
| | | TPC-SRS-RNTI, C-RNTI, MCS-C- | |
| | | RNTI, or CS-RNTI(s) | |
| UE Specific | UE | C-RNTI, or MCS-C-RNTI, or CS- | User specific |
| | Specific | RNTI(s) | PDSCH |
| | | | decoding |

Table 4 shows DCI formats transmitted on the PDCCH.

TABLE 4

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM symbol(s) |
| | where UE may assume no transmission is intended for the UE |
| 2_2 | Transmission of TPC commands for PUCCH and PUSCH |
| 2_3 | Transmission of a group of TPC commands for SRS transmissions |
| | by one or more UEs |

DCI format 0_0 may be used to schedule a TB-based (or TB-level) PUSCH, and DCI format 0_1 may be used to schedule a TB-based (or TB-level) PUSCH or a code block group (CBG)-based (or CBG-level) PUSCH. DCI format 1_0 may be used to schedule a TB-based (or TB-level) PDSCH, and DCI format 1_1 may be used to schedule a TB-based (or TB-level) PDSCH or a CBG-based (or CBG-level) PDSCH (DL grant DCI). DCI format 0_0/0_1 may be referred to as UL grant DCI or UL scheduling information, and DCI format 1_0/1_1 may be referred to as DL grant DCI or DL scheduling information. DCI format 2_0 is used to deliver dynamic slot format information (e.g., a dynamic slot format indicator (SFI)) to a UE, and DCI format 2_1 is used to deliver DL pre-emption information to a UE. DCI format 2_0 and/or DCI format 2_1 may be delivered to a corresponding group of UEs on a group common PDCCH which is a PDCCH directed to a group of UES.

DCI format 0_0 and DCI format 1_0 may be referred to as fallback DCI formats, whereas DCI format 0_1 and DCI format 1_1 may be referred to as non-fallback DCI formats. In the fallback DCI formats, a DCI size/field configuration is maintained to be the same irrespective of a UE configuration. In contrast, the DCI size/field configuration varies depending on a UE configuration in the non-fallback DCI formats.

A CCE-to-REG mapping type is configured as one of an interleaved CCE-to-REG type and a non-interleaved CCE-to-REG type.
Non-interleaved CCE-to-REG mapping (or localized CCE-to-REG mapping) (FIG. 5): 6 REGs for a given CCE are grouped into one REG bundle, and all of the REGs for the given CCE are contiguous. One REG bundle corresponds to one CCE.
Interleaved CCE-to-REG mapping (or distributed CCE-to-REG mapping): 2, 3 or 6 REGs for a given CCE are grouped into one REG bundle, and the REG bundle is interleaved within a CORESET. In a CORESET including one or two OFDM symbols, an REG bundle includes 2 or 6 REGs, and in a CORESET including three OFDM symbols, an REG bundle includes 3 or 6 REGs. An REG bundle size is set on a CORESET basis.

FIG. 6 illustrates an exemplary PDSCH reception and ACK/NACK transmission process. Referring to FIG. 6, the UE may detect a PDCCH in slot #n. The PDCCH includes DL scheduling information (e.g., DCI format 1_0 or DCI format 1_1), and indicates a DL assignment-to-PDSCH offset, K0 and a PDSCH-HARQ-ACK reporting offset, K1. For example, DCI format 1_0 or DCI format 1_1 may include the following information.
Frequency domain resource assignment: Indicates an RB set allocated to a PDSCH.
Time domain resource assignment: Indicates K0 (e.g., slot offset), the starting position (e.g., OFDM symbol index) of the PDSCH in slot #n+K0, and the duration (e.g., the number of OFDM symbols) of the PDSCH. As described above, a row index of pdsch-TimeDomain AllocationList provided UE-commonly or UE-specifically may be indicated by a TDRA field.
PDSCH-to-HARQ_feedback timing indicator: Indicates K1.
HARQ process number (4 bits): Indicates the HARQ process ID of data (e.g., a PDSCH or TB).
PUCCH resource indicator (PRI): Indicates a PUCCH resource to be used for UCI transmission among a plurality of PUCCH resources in a PUCCH resource set.

After receiving a PDSCH in slot #(n+K0) according to the scheduling information of slot #n, the UE may transmit UCI on a PUCCH in slot #(n+K1). The UCI may include an HARQ-ACK response to the PDSCH. FIG. 5 is based on the assumption that the SCS of the PDSCH is equal to the SCS of the PUCCH, and slot #n1=slot #(n+K0), for convenience, which should not be construed as limiting the disclosure. When the SCSs are different, K1 may be indicated/interpreted based on the SCS of the PUCCH.

In the case where the PDSCH is configured to carry one TB at maximum, the HARQ-ACK response may be configured in one bit. In the case where the PDSCH is configured to carry up to two TBs, the HARQ-ACK response may be configured in 2 bits if spatial bundling is not configured and in 1 bit if spatial bundling is configured. When slot #(n+K1) is designated as an HARQ-ACK transmission timing for a plurality of PDSCHs, UCI transmitted in slot #(n+K1) includes HARQ-ACK responses to the plurality of PDSCHs.

Whether the UE should perform spatial bundling for an HARQ-ACK response may be configured for each cell group (e.g., by RRC/higher layer signaling). For example, spatial bundling may be configured for each individual HARQ-ACK response transmitted on the PUCCH and/or HARQ-ACK response transmitted on the PUSCH.

When up to two (or two or more) TBs (or codewords) may be received at one time (or schedulable by one DCI) in a corresponding serving cell (e.g., when a higher layer parameter maxNrofCodeWordsScheduledByDCI indicates 2 TBs), spatial bundling may be supported. More than four layers may be used for a 2-TB transmission, and up to four layers may be used for a 1-TB transmission. As a result, when spatial bundling is configured for a corresponding cell group, spatial bundling may be performed for a serving cell in which more than four layers may be scheduled among serving cells of the cell group. A UE which wants to transmit an HARQ-ACK response through spatial bundling may generate an HARQ-ACK response by performing a (bit-wise) logical AND operation on A/N bits for a plurality of TBs.

For example, on the assumption that the UE receives DCI scheduling two TBs and receives two TBs on a PDSCH based on the DCI, a UE that performs spatial bundling may generate a single A/N bit by a logical AND operation between a first A/N bit for a first TB and a second A/N bit for a second TB. As a result, when both the first TB and the second TB are ACKs, the UE reports an ACK bit value to a BS, and when at least one of the TBs is a NACK, the UE reports a NACK bit value to the BS.

For example, when only one TB is actually scheduled in a serving cell configured for reception of two TBs, the UE may generate a single A/N bit by performing a logical AND operation on an A/N bit for the one TB and a bit value of 1. As a result, the UE reports the A/N bit for the one TB to the BS.

There are plurality of parallel DL HARQ processes for DL transmissions at the BS/UE. The plurality of parallel HARQ processes enable continuous DL transmissions, while the BS is waiting for an HARQ feedback indicating successful or failed reception of a previous DL transmission. Each HARQ process is associated with an HARQ buffer in the medium access control (MAC) layer. Each DL HARQ process manages state variables such as the number of MAC physical data unit (PDU) transmissions, an HARQ feedback for a MAC PDU in a buffer, and a current redundancy version. Each HARQ process is identified by an HARQ process ID.

FIG. 7 illustrates an exemplary PUSCH transmission procedure. Referring to FIG. 7, the UE may detect a PDCCH in slot #n. The PDCCH includes DL scheduling information (e.g., DCI format 1_0 or 1_1). DCI format 1_0 or 1_1 may include the following information.
Frequency domain resource assignment: Indicates an RB set assigned to the PUSCH.
Time domain resource assignment: Indicates a slot offset K2 and the starting position (e.g., OFDM symbol index) and duration (e.g., the number of OFDM symbols) of the PUSCH in a slot. The starting symbol and length of the PUSCH may be indicated by a start and length indicator value (SLIV), or separately.

The UE may then transmit a PUSCH in slot #(n+K2) according to the scheduling information in slot #n. The PUSCH includes a UL-SCH TB.

### DRX (Discontinuous Reception)

### (1) RRC_CONNECTED DRX

FIG. 8 is a diagram illustrating a DRX operation of a UE according to an embodiment of the disclosure.

The UE may perform a DRX operation in the afore-described/proposed procedures and/or methods. A UE configured with DRX may reduce power consumption by receiving a DL signal discontinuously. DRX may be performed in an RRC_IDLE state, an RRC_INACTIVE state, and an RRC_CONNECTED state. The UE performs DRX to receive a paging signal discontinuously in the RRC_IDLE state and the RRC_INACTIVE state. DRX in the RRC_CONNECTED state (RRC_CONNECTED DRX) will be described below.

Referring to FIG. 8, a DRX cycle includes an On Duration and an Opportunity for DRX. The DRX cycle defines a time interval between periodic repetitions of the On Duration. The On Duration is a time period during which the UE monitors a PDCCH. When the UE is configured with DRX, the UE performs PDCCH monitoring during the On Duration. When the UE successfully detects a PDCCH during the PDCCH monitoring, the UE starts an inactivity timer and is kept awake. On the contrary, when the UE fails in detecting any PDCCH during the PDCCH monitoring, the UE transitions to a sleep state after the On Duration. Accordingly, when DRX is configured, PDCCH monitoring/reception may be performed discontinuously in the time domain in the afore-described/proposed procedures and/or methods. For example, when DRX is configured, PDCCH reception occasions (e.g., slots with PDCCH SSs) may be configured discontinuously according to a DRX configuration in an embodiment of the disclosure. On the contrary, when DRX is not configured, PDCCH monitoring/reception may be performed continuously in the time domain. For example, when DRX is not configured, PDCCH reception occasions (e.g., slots with PDCCH SSs) may be configured continuously in an embodiment of the disclosure. Irrespective of whether DRX is configured, PDCCH monitoring may be restricted during a time period configured as a measurement gap.

Table 5 describes a DRX operation of a UE (in the RRC_CONNECTED state). Referring to Table 5, DRX configuration information is received by higher-layer signaling (e.g., RRC signaling), and DRX ON/OFF is controlled by a DRX command from the MAC layer. Once DRX is configured, the UE may perform PDCCH monitoring discontinuously in performing the afore-described/proposed procedures and/or methods.

TABLE 5

| | Type of signals | UE procedure |
|---|---|---|
| 1st step | RRC signalling | Receive DRX configuration information |
| | (MAC- | |
| | CellGroupConfig | |
| 2nd Step | MAC CE | Receive DRX command |
| | ((Long) DRX | |
| | command MAC CE) | |
| 3rd Step | — | Monitor a PDCCH during an on-duration of a |
| | | DRX cycle |

MAC-CellGroupConfig includes configuration information required to configure MAC parameters for a cell group. MAC-CellGroupConfig may also include DRX configuration information. For example, MAC-CellGroupConfig may include the following information in defining DRX.
Value of drx-OnDurationTimer: defines the duration of the starting period of the DRX cycle.
Value of drx-InactivityTimer: defines the duration of a time period during which the UE is awake after a PDCCH occasion in which a PDCCH indicating initial UL or DL data has been detected
Value of drx-HARQ-RTT-TimerDL: defines the duration of a maximum time period until a DL retransmission is received after reception of a DL initial transmission.
Value of dix-HARQ-RTT-TimerDL: defines the duration of a maximum time period until a grant for a UL retransmission is received after reception of a grant for a UL initial transmission.
drx-LongCycleStartOffset: defines the duration and starting time of a DRX cycle.
drx-ShortCycle (optional): defines the duration of a short DRX cycle.

When any of drx-OnDurationTimer, drx-InactivityTimer, drx-HARQ-RTT-TimerDL, and drx-HARQ-RTT-TimerDL is running, the UE performs PDCCH monitoring in each PDCCH occasion, staying in the awake state.

### RRC_IDLE DRX

In the RRC_IDLE and RRC_INACTIVE states, DRX is used to receive a paging signal discontinuously. For simplicity, DRX performed in the RRC_IDLE (or RRC_INACTIVE) state will be referred to as RRC_IDLE DRX.

Therefore, if DRX is configured, PDCCH monitoring/reception may be performed discontinuously in the time domain in performing the above-described/proposed procedures and/or methods are performed.

FIG. 9 illustrates an exemplary DRX cycle for paging.

Referring to FIG. 9, DRX may be configured for discontinuous reception of a paging signal. The UE may receive DRX configuration information from the BS by higher-layer (e.g., RRC) signaling. The DRX configuration information may include configuration information related to a DRX cycle, a DRX offset, a DRX timer, and the like. The UE repeats an On duration and a Sleep duration according to the DRX cycle. The UE may operate in a wakeup mode during the On duration and in a sleep mode during the Sleep duration.

In the wakeup mode, the UE may monitor a PO to receive a paging message. A PO means a time resource/interval (e.g., subframe or slot) in which the UE expects to receive a paging message. PO monitoring includes monitoring a PDCCH (MPDCCH or NPDCCH) scrambled with a P-RNTI (hereinafter, referred to as a paging PDCCH) on a PO. The paging message may be included in the paging PDCCH or in a PDSCH scheduled by the paging PDCCH. One or more POs may be included in a paging frame (PF), and the PF may be periodically configured based on a UE ID. A PF may correspond to one radio frame, and the UE ID may be determined based on the International Mobile Subscriber Identity (IMSI) of the UE. When DRX is configured, the UE monitors only one PO per DRX cycle. When the UE receives a paging message indicating a change of its ID and/or system information on a PO, the UE may perform a RACH procedure to initialize (or reconfigure) a connection with the BS, or receive (or obtain) new system information from the BS. Therefore, PO monitoring may be performed discontinuously in the time domain to perform a RACH procedure for connection to the BS or to receive (or obtain) new system information from the BS in the above-described procedures and/or methods.

FIG. 10 illustrates an extended DRX (eDRX) cycle.

According to the DRX cycle configuration, the maximum cycle duration may be limited to 2.56 seconds. However, in the case of a UE that intermittently performs data transmission/reception, such as an MTC UE or an NB-IoT UE, unnecessary power consumption may occur during the DRX cycle. In order to further reduce the power consumption of the UE, a method of significantly extending the DRX cycle based on a power saving mode (PSM) and a paging time window or paging transmission window (PTW) has been introduced. The extended DRX cycle is simply referred to as an eDRX cycle. Specifically, paging hyper-frames (PHs) are periodically configured based on the UE ID, and a PTW is defined in the PHs. The UE may perform a DRX cycle in the PTW duration to switch to the wakeup mode on the PO thereof to monitor the paging signal. One or more DRX cycles (e.g., wake-up mode and sleep mode) of FIG. 9 may be included in the PTW duration. The number of DRX cycles in the PTW duration may be set by the BS through a higher layer (e.g., RRC) signal.

### Enhanced SCell DRX for UE Power Saving

In NR, a DRX operation may be used to reduce unnecessary power consumption of a UE. For DRX, a structure for UEs in the RRC_IDLE state and a structure for UEs in the RRC_CONNECTED state are defined separately, and both DRX structures are designed to reduce unnecessary power consumption during the other periods by defining periodic occurrences of a period during which a UE may expect to receive a DL signal. Characteristically, in C-DRX (i.e. DRX applied to UEs in the RRC_CONNECTED state), the starting position of an On-duration occurs periodically based on the Rel-17 standard of NR, and the size of a periodicity (e.g., DRX cycle) configurable for it may be determined by a higher layer parameter that the BS provides to the UE. Table 6 is an excerpt from the TS 38.331 standard, describing some of parameters that determine a C-DRX cycle.

TABLE 6

| | |
|---|---|
| DRX-Config ::= | SEQUENCE { |
| drx-onDuration Timer | CHOICE { |
| subMilliSeconds | INTEGER (1..31), |
| milliSeconds | ENUMERATED { |

```
    ms1, ms2, ms3, ms4, ms5, ms6, ms8, ms10, ms20, ms30, ms40, ms50, ms60,
    ms80, ms100, ms200, ms300, ms400, ms500, ms600, ms800, ms1000,
ms1200,
    ms1600, spare8, spare7, spare6, spare5, spare4, spare3, spare2, spare1 }
```

| | |
|---|---|
| | }, |
| drx-Inactivity Timer | ENUMERATED { |

```
    ms0, ms1, ms2, ms3, ms4, ms5, ms6, ms8, ms10, ms20, ms30, ms40, ms50,
ms60,
    ms80, ms100, ms200, ms300, ms500, ms750, ms1280, ms1920, ms2560,
```

| | |
|---|---|
| spare9, | spare8, spare7, spare6, spare5, spare4, spare3, spare2, spare1}, |

| | |
|---|---|
| drx-HARQ-RTT-TimerDL | INTEGER (0..56), |
| drx-HARQ-RTT-TimerUL | INTEGER (0..56), |

```
    drx-Retransmission TimerDL ENUMERATED {
    sl0, sl1, sl2, sl4, sl6, sl8, sl16, sl24, sl33, sl40, sl64, sl80, sl96,
    sl112, sl128, sl160, sl320, spare15, spare14, spare13, spare12, spare11,
spare10,
    spare9, spare8, spare7, spare6, spare5, spare4, spare3, spare2, spare1},
    drx-RetransmissionTimerUL ENUMERATED {
    sl0, sl1, sl2, sl4, sl6, sl8, sl16, sl24, sl33, sl40, sl64, sl80, sl96, sl112, sl128,
    sl160, sl320, spare15, spare14, spare13, spare12, spare11, spare10, spare9,
    spare8, spare7, spare6, spare5, spare4, spare3, spare2, spare1 },
    drx-LongCycleStartOffset CHOICE {
```

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |

```
    drx-ShortCycleENUMERATED {
    ms2, ms3, ms4, ms5, ms6, ms7, ms8, ms10, ms14, ms16, ms20, ms30, ms32,
    ms35, ms40, ms64, ms80, ms128, ms160, ms256, ms320, ms512, ms640,
spare9,
    spare8, spare7, spare6, spare5, spare4, spare3, spare2, spare1 },
    drx-ShortCycleTimer INTEGER (1..16)} OPTIONAL, -- Need R
    drx-SlotOffset INTEGER (0..31)
  }
  DRX-ConfigExt-v1700 ::= SEQUENCE {
```

| | |
|---|---|
| drx-HARQ-RTT-TimerDL-r17 | INTEGER (0..448), |
| drx-HARQ-RTT-TimerUL-r17 | INTEGER (0..448) |

}

Further, carrier aggregation (CA) may be used in NR to efficiently utilize frequencies and increase a maximum transmission rate. When CA is used, the UE may be configured with a plurality of serving cells in the RRC_CONNECTED state, and when the UE is configured with a DRX operation, the UE may perform the DRX operation in the configured cells. In order to achieve a power saving gain of the UE and efficiently operate CA, methods of controlling SCells may be used in NR. For example, when scheduling is required for no SCells, the BS may support the UE to obtain the power saving effect by switching all or some of the SCells to a dormancy BWP state. In addition, the BS may configure and operate two DRX groups. In this case, one group may be used by applying DRX parameters used for a PCell as they are, whereas some SCells may be configured as the other DRX group (i.e., a secondary DRX group) and subject to separately configured DRX parameters. Most of the parameters for the secondary DRX group share parameters configured for the DRX group of the PCell, and some timers (i.e. drx-onDurationTimer and drx-InactivityTimer) may be configured separately. The timer configuration for the secondary DRX group may be suitable for the purpose of increasing the power saving gain of the UE by separately controlling a period during which the UE performs PDCCH monitoring at the position of an SCell belonging to a different frequency range from the PCell.

In 3GPP, various scenarios and candidate technologies are under discussion to support XR services. XR is characterized in that low latency should be satisfied, while high data rates are guaranteed, and at the same time, high power consumption of UEs is expected. Accordingly, various power saving techniques are considered to increase battery efficiency. To prevent unnecessary power consumption of UEs, a situation where a DRX operation is also applied to XR UEs may be considered. Further, a CA situation may be considered for the purpose of providing a high data rate to a UE and achieving low latency.

A DRX operation may be useful in a system in which periodic traffic is expected. On the contrary, when a traffic generation period is not regular and there is a high level of latency requirement for traffic, the DRX operation may increase latency, and in a worse case, result in traffic transmission and reception failure. For example, in the case of XR traffic, although it is expected that traffic will be generated with a specific periodicity, jitter caused by information processing and event occurrence needs to be considered. In this case, the occurrence of jitter may mean that traffic is generated or transmitted and received not at a fixed time but earlier or later than an expected time. For example, when the expected time of traffic generation or transmission and reception ist, it may be necessary to design a system which considers the possibility of traffic generation or transmission and reception within a range of [t−t′, t+t′] due to the occurrence of jitter.

In a situation where a DRX structure is used, one way to ensure transmission and reception of traffic generated every DRX cycle in consideration of the influence of jitter is to increase the duration of a period (e.g. On-duration timer) during which the UE maintains PDCCH monitoring even when there is no PDCCH transmission or reception. However, this method may be disadvantageous in that the PDCCH monitoring period increases regardless of whether traffic is generated actually, thereby significantly increasing the average power consumption of the UE. Particularly in a CA situation, the UE should perform PDCCH monitoring in a plurality of cells every DRX cycle, making the method of increasing the On-durations of all cells unsuitable.

As such, a method using a secondary DRX group may be useful in order to prevent power consumption caused by PDCCH monitoring in an SCell. Since SCells belonging to the secondary DRX group may have a shorter drx-onDurationTimer and drx-Inactivity Timer than the PCell and SCells that are not included in the secondary DRX group, they may have a relatively short active time (i.e. a time period during which a PDCCH is to be monitored), and thus may be expected to have a favorable effect on power saving. In addition, when an SCell dormancy indication that may be indicated within an active time and a MAC CE-based DRX command method are used within the active time, an SCell operation may be determined according to an indication of the BS, which may be useful for obtaining a more flexible power saving effect. However, all of these methods are power saving techniques applicable after the start of an active time, and since in all of the PCell and SCells, On-durations start at the same time, and PDCCH monitoring starts simultaneously with the start of the On-durations, only a unidirectional power saving effect may be obtained.

As a power saving technique that may be applied at the starting time of an On-duration, a method of indicating a dormancy state for cells in which traffic is not scheduled before an On-duration starts (i.e., indicating switching to a dormant BWP for some SCells) using a wake up signal (hereinafter, referred to as a WUS) introduced in Rel-16 NR may be used. Because this method may prevent the UE from starting PDCCH monitoring in an SCell at the starting position of On-duration, it is advantageous in that when the BS is capable of predicting a traffic state, an unnecessary UE operation may be prevented. However, this method may be applied only to UEs with WUS capabilities, and when the characteristics of traffic are not suitable for WUS monitoring, for example, when traffic may be expected to occur every DRX cycle like XR, and the periodicity of the traffic is short, the method may reduce the power saving efficiency of the UE.

To address the above problems, the disclosure proposes methods of reducing unnecessary PDCCH monitoring of a UE at the starting time of an On-duration in order to increase the power saving effect of the UE performing a DRX operation in a PCell and one or more SCells. These methods may be advantageous for obtaining a power saving gain in a transmission/reception structure of traffic which is periodic and vulnerable to jitter.

In the specification, the proposals are described mainly based on a situation where a C-DRX operation is applied to a UE in the RRC_CONNECTED state in a 3GPP NR system, which should not be construed as limiting, and may also be applied to other methods (e.g. DRX applied to a UE in the RRC_IDLE state) in which a specific period during which the UE does not need to expect reception of a DL signal may be defined with a periodicity. Therefore, for the convenience of description, the term DRX is used as a general concept covering C-DRX.

The disclosure exemplifies a case where one PCell and a plurality of SCells are used by applying CA in a 3GPP NR system, to which the proposed methods are not limited, and the concept of PCell may be extended to mean a cell in which a UE performs a main operation for maintaining connection to a cell, such as initial access, and which may control other SCells. Further, the concept of SCell may be extended to mean a cell which is added to increase the capacity of traffic and thus capable of PDCCH transmission and reception and in which some operations may be controlled by a PCell. In addition, although the application of dual connectivity (hereinafter, referred to as DC) is not separately described, the proposed methods may be generally applied to a PSCell and SCells configured with a CA relationship with the PSCell in a situation where DC is configured. Therefore, the proposed methods may be applied to all types of wireless communication channel establishment methods in which a single UE transmits and receives traffic through a plurality of cells (or carriers). Hereinbelow, PCell and SCell are used as general terms representing these concepts for convenience of description in the disclosure.

In the disclosure, a DRX operation is described mainly as a structure in which a period during which a UE may start PDCCH monitoring is repeated with a periodicity, which should not be construed as limiting, and the disclosure may also be applied to a DRX operation with a non-periodic structure. For example, the disclosure may be applied to a DRX operation with a non-integer periodicity or a DRX operation in which the size of a DRX cycle is represented in the form of a pattern. Although the disclosure is described based on an NR system, it is not limited thereto. Further, although the disclosure is described based on the characteristics and structure of XR services, it is not limited to the XR services. Each of the proposed methods of the disclosure may be performed independently without a separate combination, or one or more methods may be performed in conjunction with each other. Some terms, symbols, and orders used for the description of the disclosure may be replaced with other terms, symbols, and orders.

For example, a case is considered in which traffic that a UE expects to receive has a periodicity, but it is difficult to predict an accurate transmission and reception timing of the traffic due to jitter. In this regard, frequency resources in which the UE may expect to transmit/receive a specific signal/channel may be allowed restrictively during a specific period to obtain power saving efficiency, while minimizing the impact of latency of traffic transmission and reception. Specifically, the transmission/reception of the specific signal/channel may be determined based on PDCCH monitoring of the UE for specific RNTIs, and frequency resources in which the transmission/reception may be expected may correspond to carrier resources in which PDCCH transmission and traffic transmission/reception may be performed independently. For example, the frequency resources may correspond to the concept of a serving cell defined in a system such as 3GPP LTE/NR, and include PCell, SCell, and PSCell. Although the following description is given in the context of the concept of serving cells including a PCell and an SCell, the proposed methods may also be applied to a case where a UE simultaneously uses a plurality of frequency resources which may generally be operated separately.

Further, some time period during which transmission and reception of a specific signal/channel may be expected may be determined as a period during the UE performs PDCCH monitoring for specific RNTIs. For example, the period may correspond to an On-duration (i.e. a period during which a drx-onDurationTimer is started and maintained) defined and used in a system such as 3GPP LTE/NR, and also correspond to an active time (i.e. a period during which a drx-onDuration Timer or a drx-InactivityTimer is maintained). In the disclosure, a method of controlling PDCCH monitoring performed by a UE at a starting position that occurs every DRX cycle is considered, and a method of controlling an On-duration is described mainly as this proposed method. However, unless otherwise specified, the proposed method may also be applied to a period defined to determine the transmission and reception timings of other general signals/channels.

It may be configured that the proposed method is applied only when a UE receives related configuration information from a BS (or a core network). A higher layer signal (e.g. SIB or RRC signaling) may be used as the configuration information, or the configuration information and a method of indicating activation/deactivation of the configuration information by separate signaling (e.g. DCI or MAC) may be used together. Further, the UE may be configured to report information (e.g. capability) about whether it supports the proposed method, and the BS (or the core network) may be configured to receive the information.

FIG. 11 is a diagram referred to for describing traffic generation in each cell in a CA situation and a problem to be solved in the disclosure in relation to the traffic generation. In FIG. 11, an element FG101 represents an example of the probabilities of generating traffic to be provided to a UE over time. For the convenience of description, a case where the generation and transmission/reception timing of traffic occurs in the form of a normal distribution with 10 as an average is illustrated. However, this is only an example, and the proposed method may also be applied to a case where other probability distributions are observed or it is difficult to assume an actual probability distribution. In a period (b), the probability of generating and transmitting/receiving traffic is highest, and the BS may generally configure an On-duration for a UE performing a DRX operation, so that the UE may perform PDCCH monitoring in the period (b). However, traffic may be generated or need to be transmitted and received earlier or later than 10 due to jitter, and the BS may configure a longer On-duration before and after the period (b) to reduce the latency of traffic transmission/reception and traffic missing. When CA is applied and thus the UE performs PDCCH monitoring in one or more cells, a long On-duration needs to be configured at least in the region of a PCell in consideration of the impact of jitter. For example, periods (a) and (c) may be additionally configured as the region of the On-duration (FG102). In general, an On-duration in an SCell may also follow the definition of an On-duration in the PCell. However, since extended PDCCH monitoring in all cells may be disadvantageous in terms of power consumption, the BS may set an On-duration timer to a small value or stop PDCCH monitoring for some SCells by indicating a secondary DRX group configuration or a dormancy indication. These operations may be applied to a latter half of the On-duration or active time, and in the example of the drawing, the period (c) may be considered as a period during which PDCCH monitoring (for the SCell) is dropped for power saving (FG103). On the other hand, the period (a) may not be suitable for stopping PDCCH monitoring of the UE based on the current Rel-17 NR standard. As described before, when a WUS is used, an SCell dormancy indication may be pre-indicated to prevent PDCCH monitoring in the SCell in the period (a). However, this forces the UE to perform WUS monitoring, thereby decreasing or even increasing a power consumption gain in a scenario where the WUS is not suitable.

### [Proposal 1] Specifying DRX Group Specific Starting Offset

A method of configuring a DRX group specific offset parameter for each DRX group and determining the starting time of an On-duration differently for each DRX group is proposed. A DRX group refers to a set of serving cells configured to perform the same/similar DRX operation, and for example, a set of serving cells configured by RRC to have the same DRX active time as defined in the TS 38.321 standard of 3GPP NR may be considered. For convenience of description, the proposed method is mainly described based on a DRX group defined in the 3GPP TS 38.321 standard. However, unless otherwise specified, the term DRX group may be used in a general sense to refer to a set of serving cells configured to share a specific purpose and operation. For example, the proposed method may be defined as a relationship between a PCell and an SCell. In this case, the proposed method may also be applied to a structure in which the starting time of an On-duration in a PCell and the starting times of On-durations in other SCells are indicated differently.

The DRX group specific offset parameter may include indication information for indicating the starting time of an On-duration. For example, the indication information may be expressed as an absolute time in ms or as a transmission unit used for transmission and reception, such as an OFDM symbol or slot.

In a specific example, a situation is considered in which a BS configures a plurality of DRX groups, one DRX group becomes a base DRX group (hereinafter, referred to as a Base DRX group), and the Base DRX group refers to a group configured with all parameters for a DRX operation. In addition, a situation is considered in which some parameters for a DRX operation may be configured separately for the remaining DRX groups (hereinafter, referred to as Add DRX groups) except for the Base DRX group among the plurality of DRX groups, and parameters of the Base DRX group may be shared as the remaining parameters that are not configured separately for the DRX operation. In this case, the parameters configured separately for the Add DRX groups may include indication information for indicating the starting times of On-durations by applying Proposal 1. For example, in the 3GPP NR standard, the information for indicating the starting time of an On-duration may be RRC-configured drx-SlotOffset information transmitted by the BS.

When the proposed information for separately indicating the starting time of an On-duration is applied, at least one of the following options may be used to determine the starting time of an On-duration in an Add DRX group based on configured information.
Option 1-1) Apply an offset for the Add DRX group using the same reference point as the Base DRX group
Option 1-2) Apply an offset for the Add DRX group based on the starting time of an On-duration in the Base DRX group

Option 1-1 is a method of using a reference point (i.e. a point before an offset is applied) used to determine the starting time of an On-duration in the Base DRX group as a reference point to determine the starting time of an On-duration in the Add DRX group. For example, a situation may be considered in which based on the 3GPP NR standard, for the starting time of the On-duration of the Base DRX group, an offset in ms is determined using a parameter drx-LongCycleStartOffset, and an offset in 1/32 ms is additionally determined using a parameter drx-SlotOffset. In this case, one method to apply option 1-1 is to set the starting time of the On-duration of the Add DRX group only based on parameters configured separately for the Add DRX group without considering the above offset values. This may be advantageous in that it allows the BS to control the starting time of the On-duration of the Add DRX group more flexibly.

FIG. 12 illustrates an example of option 1-1. Referring to FIG. 12, an On-duration FG201 of a Base DRX group may be configured to start at a position FG205 by applying an offset value FG204 from a specific time point FG203, and an On-duration FG202 of an Add DRX group may share the specific reference time point FG203 used by the Base DRX group, and its starting position FG207 may be determined by applying a separately specified offset value FG206.

Option 1-2 is a method of determining the starting time of an On-duration of an Add DRX group by applying an offset based on a determined starting time of an On-duration of a Base DRX group. A situation may be considered in which based on the 3GPP NR standard, for the starting time of the On-duration of the Base DRX group, an offset in ms is determined using the parameter drx-LongCycleStartOffset, and an offset in 1/32 ms is additionally determined using the parameter drx-SlotOffset. In this case, as an example of applying option 1-2, the starting time of the On-duration of the Add DRX group may be determined by additionally applying parameters configured separately for the Add DRX group based on the starting time of the On-duration of the Base DRX group determined by reflecting the above offset values. This may be advantageous in that it may reduce signaling overhead because a position may be expressed by providing only additional offset information, when the On-duration of the Add DRX group always starts later than the On-duration of the Base DRX group.

FIG. 13 illustrates an example of option 1-2. Referring to FIG. 13, an On-duration of a Base DRX group may be configured to start at a position FG305 by applying an offset value FG304 from a specific time point FG303, and the starting position FG307 of an On-duration of an Add DRX group may be determined by additionally applying a separately specified offset value FG306 from the determined starting position FG305 of the On-duration of the Base DRX group.

A situation is considered in which a UE receives a higher layer signal (e.g. an SIB or RRC signaling) including information about DRX and a plurality of serving cells from a BS, and performs DRX and CA operations based on the received higher layer signal. The information about the DRX and the plurality of serving cells may include configuration information about a plurality of DRX groups, at least one of them may be configuration information about a Base DRX group, and the other may include configuration information about an Add DRX group. The configuration information about the Add DRX group may include a separate offset value for determining the starting position of an On-duration, and the UE may be configured to determine DRX configuration information that is not included in the configuration information about the Add DRX group, referring to the information about the Base DRX group. In addition, the configuration information may include information about a DRX group to which each serving cell belongs, and when there is a serving cell for which a DRX group is not configured, it may be determined to belong to the Base DRX group.

The UE may expect an On-duration to start in each serving cell every DRX cycle based on the received configuration information, and determine the starting position of the On-duration in each serving cell based on the configuration information about the DRX group to which the serving cell belongs.

The UE may be configured to perform an On-duration-related operation (e.g. PDCCH monitoring, CSI report, and so on) only for serving cells where On-durations have started, without performing the related operation at the positions of the other serving cells until On-durations start.

For example, a case may be considered where a DRX structure is used for the purpose of transmitting and receiving traffic of a service having specific requirements. In this case, the UE may be configured with a secondary DRX group, and receive a value of an offset parameter (e.g. at the slot or symbol level) for determining the starting position of an On-duration in a serving cell belonging to the secondary DRX group through an RRC parameter (i.e. DRX-ConfigSecondaryGroup) for configuring the secondary DRX group. The UE may use general DRX configuration information (i.e., information included in a DRX-Config 1E) to determine the starting position of an On-duration (i.e., a position where a drx-onDuration Timer starts) in a serving cell that does not belong to the secondary DRX group, and use the configuration information about the secondary DRX group (i.e., information included in a DRX-ConfigSecondaryGroup IE) to determine the starting position of an On-duration in a serving cell included in the secondary DRX group.

FIG. 14 illustrates an exemplary sequence of UE operations.

Referring to FIG. 14, a UE may receive configuration information including information (e.g., a DRX cycle, offset information, and so on) related to a DRX group and the starting position of an On-duration from a BS, and determine whether to apply a proposed method based on the configuration information. For example, the configuration information may be received through a higher layer signal (e.g. an SIB or RRC signaling) (FG401).

The UE may determine the starting position of an On-duration in each configured serving cell every DRX cycle based on the received configuration information. The starting position of each On-duration may be different for each DRX group to which each serving cell belongs (FG402).

The UE may perform an on-duration operation (e.g. PDCCH monitoring, CSI reporting, and so on) in each serving cell in which an On-duration has started every DRX cycle (FG403).

For example, a situation is considered where the BS determines information about DRX and a plurality of serving cells, transmits the information to the UE through a higher layer signal (e.g. an SIB or RRC signaling), and assumes that the UE performs DRX and CA operations based on the transmitted higher layer signal. The information about the DRX and the plurality of serving cells may include configuration information about a plurality of DRX groups, at least one of them may be configuration information about a Base DRX group, and the other may include configuration information about an Add DRX group. The configuration information about the Add DRX group may include a separate offset value for determining the starting position of an On-duration, and the BS may expect that the UE will determine DRX configuration information that is not included in the configuration information about the Add DRX group, referring to the information about the Base DRX group. In addition, the configuration information may include information about a DRX group to which each serving cell belongs, and when there is a serving cell for which a DRX group is not configured, it may be determined to belong to the Base DRX group.

The BS may expect the UE to start an On-duration at the position of each configured serving cell based on the transmitted configuration information. The starting position of the On-duration in each serving cell may be determined based on the configuration information about the DRX group to which the serving cell belongs.

When the BS needs to transmit/receive a specific signal/channel, it may transmit/receive the specific signal/channel through serving cells in which On-durations have started and been maintained.

FIG. 16 illustrates an exemplary sequence of BS operations.

Referring to FIG. 16, a BS may determine information (e.g., a DRX cycle, offset information, and so on) related to a DRX group of a UE and the starting position of an On-duration and transmit configuration information including the information to the UE. For example, the configuration information may be transmitted through a higher layer signal (e.g. an SIB or RRC signaling) (FG501).

The BS may expect the UE to start an On-duration in each configured serving cell every DRX cycle based on the transmitted configuration information. The starting position of each On-duration may be different for a DRX group to which each serving cell belongs (FG502).

The BS may transmit/receive a necessary signal or channel in each serving cell in which an On-duration has started every DRX cycle (FG503).

Proposal 1 may have an advantageous effect in obtaining the power saving effect of a UE in a situation where traffic occurs periodically like XR, but its transmission and reception timing may be flexible due to jitter generated due to a cause such as the processing times of transmitting and receiving ends. In particular, considering a period during which traffic is likely to occur quickly but has a low probability, when the period is configured to be transmitted and received in none of all serving cells (e.g., an On-duration is not generated), a power saving gain may be expected, but latency may increase. On the contrary, when the period is configured such that transmission and reception are expected in all serving cells (e.g., an On-duration is extended), this may be advantageous in terms of latency, but the power consumption efficiency of the UE may decrease. In Proposal 1, the On-durations of some serving cells may be configured to start relatively early, thereby securing a period during which traffic transmission and reception are possible, while reducing the power consumption of the UE relatively.

### [Proposal 2] SCell On-Duration Starting in SCell Dormancy (by Default)

A method of starting an On-duration in a dormancy state in some serving cells by an indication in a higher layer signal (e.g., an SIB or RRC) is proposed. This means that the UE may start the dormancy state at the same time as the start of an On-duration without a separate indication by L1/L2 signaling. The dormancy state may refer to a state in which the UE does not perform control channel reception (e.g. PDCCH monitoring), for example, a state in which a dormant BWP is applied based on 3GPP NR. For convenience of description, a UE operation of starting an On-duration in the dormancy state in a specific serving cell is described below as the term D-dormancy, which does not limit the scope of the disclosure.

Serving cells to which the D-dormancy method is applied may correspond to all SCells except for a PCell among serving cells expected by the UE, or the BS may be configured to indicate a target serving cell through a higher layer signal. In this case, it may be expected that an On-duration will start in a serving cell to which the D-dormancy method is not applied (e.g. the PCell or a serving cell excluded from the application of the D-dormancy method by a higher layer signal) according to an existing operation. It may be configured that the existing operation follows an operation of not starting an On-duration in the dormancy state (e.g., an operation of starting an On-duration on the assumption of a non-dormant BWP) or an operation indicated by a separate L1/L2 signal (e.g. an SCell dormancy indication by a WUS).

In a situation where the D-dormancy operation is performed and the dormancy state is maintained in a specific serving cell, it may be configured that the dormancy state is terminated by an indication from the BS. In a specific example, the indication may be performed by an L1 signal (e.g., DCI) or an L2 signal (e.g., MAC signal) transmitted/received in a serving cell to which the D-dormancy operation is not applied. For example, the dormancy operation may be terminated in the serving cell maintaining the D-dormancy operation according to information of an SCell dormancy indication indicated by scheduling DCI transmitted in a cell (e.g., PCell) in which the D-dormancy operation is not performed. This may be advantageous in that the existing SCell dormancy indication operation may be reused in 3GPP NR. Alternatively, when scheduling DCI is transmitted and received in a cell in which the D-dormancy operation is not performed, and the UE detects the scheduling DCI, it may be configured that the D-dormancy operation is terminated in all serving cells. This may be advantageous in that when traffic expected to be transmitted/received is generally large and requires a high data rate, information may be provided without generating additional DCI bits. Alternatively, when scheduling DCI is transmitted/received in a cell in which the D-dormancy operation is not performed, the scheduling DCI includes cross-carrier scheduling or multi-carrier scheduling information, and the UE receives the scheduling DCI, it may be configured that the D-dormancy operation is terminated in serving cell(s) for which scheduling is performed. This is advantageous in that the D-dormancy operation for serving cells requiring traffic transmission/reception as determined by the BS is controlled without generating additional DCI bits.

In the situation where the D-dormancy operation is performed and the dormancy state is maintained in the specific serving cell, it may be configured that the dormancy state is maintained during a predetermined time period, and not maintained after the predetermined time period. In a specific example, the predetermined time period may be defined by a timer whose count starts from the starting position of an On-duration. For example, a D-dormancy timer may start simultaneously with the start of an On-duration timer in each serving cell, the dormancy state may be maintained in the serving cell as long as the D-dormancy timer runs, and when the D-dormancy timer expires, it may be configured that the dormancy state of the serving cell is terminated, and a non-dormancy BWP (e.g., a BWP other than a dormant BWP, such as an active BWP or initial BWP) starts to be applied. In another specific example, the predetermined time period may be defined by a window having a specific duration. For example, the starting time of the On-duration timer in each serving cell may be determined as the starting position of the window, and the dormancy state may be configured to be maintained during the window duration from the starting position. When another dormancy state termination condition is triggered (e.g., an indication is generated by an L1/L2 signal transmitted/received in the PCell) before the timer or the window duration ends, it may be configured that the timer or window duration ends, and whether to maintain the dormancy state depends on the result of the condition. The value of the timer or the window duration may be determined according to a rule predetermined in the standard, or may be configurable values configured by the BS and provided to the UE by a higher layer signal (e.g., an SIB or RRC).

FIG. 16 illustrates an example of the proposed method. In FIG. 16, an On-duration or active time FG601 of a PCell is valid from the starting time FG602 of the On-duration, and is not subject to the dormancy state. Further, an On-duration FG603 of an SCell has the same starting time as the On-duration of the PCell, by way of example. The D-dormancy operation is performed in the SCell from the starting time FG602 of the On-duration, and thus the dormancy state is maintained during a period FG604. The period during which the dormancy state is maintained may be terminated according to a specific condition (FG605), and after the dormancy state is terminated, the SCell may be operated in a normal On-duration or active time state.

For example, a situation is considered where the UE receives a higher layer signal (e.g., an SIB or RRC signaling) including information about DRX and a plurality of serving cells from the BS, and performs DRX and CA operations based on the received higher layer signal. The information about the DRX and the plurality of serving cells may include configuration information for supporting the D-dormancy operation, and the configuration information for supporting the D-dormancy operation may include information about serving cells to which the method is applied and/or information about the duration of a time period during which dormancy may be maintained by the D-dormancy operation.

The UE may expect an On-duration to start in each serving cell every DRX cycle based on the received configuration information. In this case, the UE may assume that a normal On-duration operation (e.g., PDCCH monitoring, CSI reporting, and so on) has started in a serving cell to which D-dormancy is not applied based on the configuration information, and a serving cell to which D-dormancy is applied has switched to/is maintained in the dormancy state, simultaneously with the start of an On-duration.

In the presence of the duration of a time period during which the dormancy state is maintained by D-dormancy, the UE may be configured to start a normal On-duration operation after the dormancy state maintaining time period ends in each serving cell.

When the dormancy state based on D-dormancy may be controlled by an L1/L2 signal, and the UE receives information of an L1/L1 signal in a serving cell in a non-dormancy state, the UE may be configured to determine whether to maintain the dormancy state in each serving cell in which the D-dormancy operation is performed, according to an indication of the received L1/L2 signal.

For example, a case may be considered where a DRX structure is sued for the purpose of transmitting and receiving traffic of a service having specific requirements. The UE may be configured with a plurality of serving cells, and the configured serving cells may include one PCell and one or more SCells. According to a configuration from the BS, the UE may assume that the D-dormancy operation is applied to all of the configured SCells or a separately indicated group of SCells. Subsequently, the UE may assume that it may perform an On-duration operation (e.g., PDCCH monitoring, CSI reporting, and so on) simultaneously with the start of an On-duration timer at the position of an On-duration that occurs every DRX cycle at the position of the PCell (or all serving cells to which the D-dormancy operation is not performed), and that the dormancy state starts (i.e., a dormant BWP is applied) simultaneously with the start of On-duration timers at the positions of all SCells (or all serving cells to which the D-dormancy operation is applied). Subsequently, when a dormancy state termination condition is satisfied while the dormancy state is maintained at the positions of all SCells (or all serving cells to which the D-dormancy operation is applied), the UE may be configured to terminate the dormancy operation (e.g., switch to a non-dormant BWP) in the serving cells. When On-duration timers are maintained in the serving cells at the ending time of the dormancy state, the UE may perform the On-duration operation. When the On-duration timers have already been terminated in the serving cells at the ending time of the dormancy state, the UE may perform a DRX operation. Alternatively, when an active time maintaining condition is satisfied (e.g., an active time is maintained in another serving cell of the same DRX group), the UE may be configured to perform necessary operations under a timer for which the active time is maintained. The dormancy state termination condition may be, for example, expiration of a timer (or window duration) for the D-dormancy operation or receiving a PDCCH at the position of the PCell (or all serving cells to which the D-dormancy operation is not performed) and performing an operation indicated by the PDCCH at the UE.

FIG. 17 illustrates an exemplary sequence of UE operations.

Referring to FIG. 17, a UE may receive configuration information including information (e.g., a DRX cycle, offset information, and so on) related to a plurality of serving cells and a D-dormancy operation from a BS and determine whether to apply a proposed method according to the configuration information. For example, the configuration information may be received through a higher layer signal (e.g., an SIB or RRC signaling) (FG701).

The UE may determine a position at which an On-duration starts every DRX cycle at the position of a PCell (or all serving cells to which the D-dormancy operation is not applied), based on information about configured serving cells (FG702).

The UE may then perform an On-duration or active time operation at the position of the PCell (or all serving cells to which the D-dormancy operation is not applied) (FG703).

Further, the UE may determine a position where an On-duration starts every DRX cycle at the position of an SCell (or all serving cells to which the D-dormancy operation is applied) determined based on the information about the configured serving cells, and may assume that the On-duration starts in the dormancy state by applying a D-dormancy operation, and maintain the dormancy state (FG704 and FG705).

Subsequently, the UE may be configured to maintain the dormancy state in a specific serving cell to which the D-dormancy operation is applied until a dormancy termination condition is satisfied for the specific serving cell (FG706). When the dormancy termination condition is satisfied for the specific serving cell to which the D-dormancy operation is applied (FG706), the UE may terminate the dormancy state in the serving cell and perform the On-duration or active time operation (FG707).

For example, a situation is considered where the BS configures information about DRX and a plurality of serving cells, transmits the information through a higher layer signal (e.g. an SIB or RRC signaling), and expects the UE to perform DRX and CA operations based on the transmitted higher layer signal. The information about the DRX and the plurality of serving cells may include configuration information for supporting a D-dormancy operation, and the configuration information for the D-dormancy operation may include information about serving cells to which the method is applied and/or information about the duration of a time period during which dormancy may be maintained by the D-dormancy operation.

The BS may expect that the UE will assume an On-duration in each serving cell every DRX cycle based on the transmitted configuration information, and assume that the UE will perform a normal On-duration operation (e.g., PDCCH monitoring, CSI reporting, and so on) in a serving cell to which D-dormancy is not applied based on the configuration information, and that the UE will switch to/maintain the dormancy state in a serving cell to which D-dormancy is applied.

The BS may configure the time period during which the dormancy state is maintained by D-dormancy, and assume that the UE will start the normal On-duration operation after the configured time period during which the dormancy state is maintained ends in each serving cell.

The BS may use an L1/L2 signal to indicate whether to maintain the state in the serving cell to which the D-dormancy operation is applied through the serving cell that is not in the dormancy state.

For example, a case may be considered where a DRX structure is used for the purpose of transmitting and receiving traffic of a service having specific requirements. The BS may configure a plurality of serving cells for the UE, and the configured serving cells may include one PCell and one or more SCells. The BS may assume that the UE will apply the D-dormancy operation to all configured SCells or a separately indicated group of SCells. Subsequently, the BS may assume that the UE will perform an On-duration operation (e.g. PDCCH monitoring, CSI reporting, and so on) at the start of an On-duration timer in the PCell (or all serving cells to which the D-dormancy operation is not applied) at the position of the On-duration that occurs periodically every DRX cycle, and that the UE will apply the dormancy state (i.e., a dormant BWP) at the start of the On-duration timer in all SCells (or all serving cells to which the D-dormancy operation is applied). When a dormancy state termination condition is satisfied while the dormancy state is maintained at the positions of all SCells (or all serving cells to which the D-dormancy operation is applied), the BS may configure the dormancy operation to be terminated (e.g. switching to a non-dormant BWP) in the serving cells. When the On-duration timers for the serving cells are maintained at the time when the dormancy state is terminated, the BS may assume that the UE will perform the On-duration operation. When the On-duration timers for the serving cells have already expired at the time when the dormancy state is terminated, the BS may expect that the UE will perform a DRX operation, or when an active time maintaining condition is satisfied (e.g. an active time is maintained in another serving cell belonging to the same DRX group), the UE will perform necessary operations under a timer for which the active time is maintained. The dormancy state termination condition may be, for example, that a timer (or window duration) for the D-dormancy operation ends, or that the BS transmits a PDCCH to the UE at the position of the PCell (or all serving cells to which the D-dormancy operation is not applied) and configures the UE to perform an operation indicated by the PDCCH. Based on the expectation and assumption of the operation of the UE as described above, the BS may perform operations such as transmitting a necessary PDCCH in a time period during which the UE may monitor the PDCCH.

FIG. 18 illustrates an exemplary sequence of BS operations.

Referring to FIG. 18, the BS may determine information (e.g. a DRX cycle, offset information, and so on) related to a plurality of serving cells and a D-dormancy operation and transmit configuration information including the information to a UE. For example, the configuration information may be received through a higher layer signal (e.g. an SIB or RRC signaling) (FG801).

The BS may determine a position at which an On-duration starts every DRX cycle at the position of a PCell (or all serving cells to which the D-dormancy operation is not applied) based on information about configured serving cells (FG802).

The BS may then perform a related operation, expecting that the UE will perform an On-duration or active time operation at the position of the PCell (or all serving cells to which the D-dormancy operation is not applied) (FG803).

In addition, the BS may determine a position at which an On-duration starts every DRX cycle at the position of an SCell (or all serving cells to which the D-dormancy operation is applied) determined based on the information about the configured serving cells, and may assume that the On-duration starts in the dormancy state by applying the D-dormancy operation, and maintain it (FG804 and FG805).

The BS may then assume that the UE will maintain the dormancy state in a specific serving cell to which the D-dormancy operation is applied until a dormancy termination condition is satisfied for the specific serving cell (FG806). When the dormancy termination condition is satisfied for the specific serving cell to which the D-dormancy operation is applied (FG806), the BS may assume that the UE will terminate the dormancy state in the serving cell and perform the On-duration or active time operation (FG807).

Proposal 2 may have an advantageous effect in obtaining the power saving effect of the UE in a situation where traffic occurs periodically like XR, but its transmission and reception timing may be flexible due to jitter generated due to a cause such as the processing times of transmitting and receiving ends. In particular, considering a period during which traffic is likely to occur quickly but has a low probability, when the period is configured to be transmitted and received in none of all serving cells (e.g., an On-duration is not generated), a power saving gain may be expected, but latency may increase. On the contrary, when the period is configured such that transmission and reception are expected in all serving cells (e.g., an On-duration is extended), this may be advantageous in terms of latency, but the power consumption efficiency of the UE may decrease. To solve this problem, SCell dormancy may be dynamically indicated using a WUS in an existing operation in 3GPP NR. However, this method may force the UE to perform an additional PDCCH monitoring operation and cause a relative decrease of power saving efficiency. In Proposal 2, when On-durations start in some serving cells, PDCCH monitoring may be temporarily suspended. Accordingly, Proposal 2 may be advantageous in obtaining a power saving efficiency gain while maintaining the impact of latency to a maximum extent possible, although an available transmission/reception data rate is reduced temporarily.

FIG. 19 is a diagram illustrating signal reception of a UE according to an embodiment. FIG. 19 may be understood as an implementation example of at least some of the above-described Proposals 1 to 5, and Proposals 1 to 5 described above may be referred to for FIG. 19.

The UE may receive DRX configuration information for a plurality of cells including at least one first cell and at least one second cell through higher layer signaling (A05).

The UE may monitor a PDCCH in at least one of the plurality of cells based on the DRX configuration information (A10).

The DRX configuration information may include information about an On-duration configured in each of the plurality of cells. An On-duration configured in the at least one second cell among the plurality of cells may start with a dormancy state in which the PDCCH is not monitored based on the DRX configuration information.

The DRX configuration information may indicate to configure an On-duration starting with the dormancy state in remaining cells excluding the at least one first cell among the plurality of cells.

The DRX configuration information may include information indicating cells configured with an On-duration starting with the dormancy state.

Upon a timer expires, monitoring of the PDCCH may be started in the On-duration configured in the at least one second cell.

The dormancy state may be maintained in the at least one second cell until a specific signal is received in the at least one first cell.

The information about the On-duration may include information about an offset from a start of a DRX cycle to an On-duration start. The information about the offset may be indicated for each cell or commonly for cells belonging to the same DRX group.

The On-duration configured in the at least one second cell may start after starting an On-duration configured in the at least one first cell.

The DRX configuration information may be configured for data having a non-integer periodicity.

FIG. 20 is a diagram illustrating signal transmission of a BS according to an embodiment. FIG. 20 may be understood as an implementation example of at least some of the above-described Proposals 1 to 5, and Proposals 1 to 5 described above may be referred to for FIG. 20.

The BS may transmit DRX configuration information for a plurality of cells including at least one first cell and at least one second cell to a UE through higher layer signaling (B05).

The BS may transmit a PDCCH to a the UE in at least one of the plurality of cells based on the DRX configuration information (B10).

The DRX configuration information may include information about an On-duration configured in each of the plurality of cells. An On-duration configured in the at least one second cell among the plurality of cells may start with a dormancy state in which the PDCCH is not monitored based on the DRX configuration information.

The DRX configuration information may indicate to configure an On-duration starting with the dormancy state in remaining cells excluding the at least one first cell among the plurality of cells.

The DRX configuration information may include information indicating cells configured with an On-duration starting with the dormancy state.

Upon a timer expires, the PDCCH may be transmitted in the On-duration configured in the at least one second cell.

The dormancy state may be maintained in the at least one second cell until a specific signal is received in the at least one first cell.

The information about the On-duration may include information about an offset from a start of a DRX cycle to an On-duration start. The information about the offset may be indicated for each cell or commonly for cells belonging to the same DRX group.

The On-duration configured in the at least one second cell may start after starting an On-duration configured in the at least one first cell.

The DRX configuration information may be configured for data having a non-integer periodicity.

FIG. 21 illustrates a communication system 1 applied to the disclosure.

Referring to FIG. 21, a communication system 1 applied to the disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an extended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g., relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the disclosure.

FIG. 22 illustrates wireless devices applicable to the disclosure.

Referring to FIG. 22, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 21.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In an embodiment of the disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In an embodiment of the disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 23 illustrates another example of a wireless device applied to the disclosure. The wireless device may be implemented in various forms according to a use-case/service (refer to FIG. 21).

Referring to FIG. 23, wireless devices 100 and 200 may correspond to the wireless devices 100 and 200 of FIG. 22 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 22. For example, the transceiver(s) 114 may include the one or more transceivers 106 and 206 and/or the one or more antennas 108 and 208 of FIG. 22. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 21), the vehicles (100b-1 and 100b-2 of FIG. 21), the XR device (100c of FIG. 21), the hand-held device (100d of FIG. 21), the home appliance (100e of FIG. 21), the IoT device (100f of FIG. 21), a digital broadcast terminal, a hologram device, a public safety device, an MTC device, a medicine device, a fintech device (or a finance device), a security device, a climate/environment device, the AI server/device (400 of FIG. 21), the BSs (200 of FIG. 21), a network node, etc. The wireless device may be used in a mobile or fixed place according to a use-example/service.

In FIG. 23, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

FIG. 24 illustrates a vehicle or an autonomous driving vehicle applied to the disclosure. The vehicle or autonomous driving vehicle may be implemented by a mobile robot, a car, a train, a manned/unmanned Aerial Vehicle (AV), a ship, etc.

Referring to FIG. 24, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 23, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the disclosure in prescribed forms. And, the respective elements or features may be considered as selective unless they are explicitly mentioned. Each of the elements or features can be implemented in a form failing to be combined with other elements or features. Moreover, it is able to implement an embodiment of the disclosure by combining elements and/or features together in part. A sequence of operations explained for each embodiment of the disclosure can be modified. Some configurations or features of one embodiment can be included in another embodiment or can be substituted for corresponding configurations or features of another embodiment. And, an embodiment may be configured by combining claims failing to have relation of explicit citation in the appended claims together or can be included as new claims by amendment after filing an application.

Those skilled in the art will appreciate that the disclosure may be carried out in other specific ways than those set forth herein without departing from the spirit and essential characteristics of the disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The disclosure is applicable to UEs, BSs, or other apparatuses in a wireless mobile communication system.

1. A method performed by a user equipment (UE), the method comprising:
receiving discontinuous reception (DRX) configuration information for a plurality of cells including at least one first cell and at least one second cell through higher layer signaling; and
monitoring a physical downlink control channel (PDCCH) in at least one of the plurality of cells based on the DRX configuration information,
wherein the DRX configuration information includes information about an On-duration configured in each of the plurality of cells, and
wherein an On-duration configured in the at least one second cell among the plurality of cells starts with a dormancy state in which the PDCCH is not monitored based on the DRX configuration information.

2. The method according to claim 1, wherein the DRX configuration information indicates to configure an On-duration starting with the dormancy state in remaining cells excluding the at least one first cell among the plurality of cells.

3. The method according to claim 1, wherein the DRX configuration information includes information indicating cells configured with an On-duration starting with the dormancy state.

4. The method according to claim 1, wherein upon a timer expires, monitoring of the PDCCH is started in the On-duration configured in the at least one second cell.

5. The method according to claim 1, wherein the dormancy state is maintained in the at least one second cell until a specific signal is received in the at least one first cell.

6. The method according to claim 1, wherein the information about the On-duration includes information about an offset from a start of a DRX cycle to an On-duration start.

7. The method according to claim 6, wherein the information about the offset is indicated for each cell or commonly for cells belonging to a same DRX group.

8. The method according to claim 1, wherein the On-duration configured in the at least one second cell starts after starting an On-duration configured in the at least one first cell.

9. The method according to claim 1, wherein the DRX configuration information is configured for data having a non-integer periodicity.

10. A non-transitory processor-readable recording medium recording a program for performing the method according to claim 1.

11. A device comprising:
a memory configured to store instructions; and
a processor configured to perform operations by executing the instructions,
wherein the operations of the processor include:
receiving discontinuous reception (DRX) configuration information for a plurality of cells including at least one first cell and at least one second cell through higher layer signaling; and
monitoring a physical downlink control channel (PDCCH) in at least one of the plurality of cells based on the DRX configuration information,
wherein the DRX configuration information includes information about an On-duration configured in each of the plurality of cells, and
wherein an On-duration configured in the at least one second cell among the plurality of cells starts with a dormancy state in which the PDCCH is not monitored based on the DRX configuration information.

12. The device according to claim 11, wherein the device is an application specific integrated circuit (ASIC) or a digital signal processing device.

13. The device according to claim 11, wherein the device is a user equipment (UE) operating in a 3rd generation partnership project (3GPP)-based wireless communication system.

14. A method performed by a base station (BS), the method comprising:
transmitting discontinuous reception (DRX) configuration information for a plurality of cells including at least one first cell and at least one second cell to a user equipment (UE) through higher layer signaling; and
transmitting a physical downlink control channel (PDCCH) to the UE in at least one of the plurality of cells based on the DRX configuration information,
wherein the DRX configuration information includes information about an On-duration configured in each of the plurality of cells, and
wherein an On-duration configured in the at least one second cell among the plurality of cells starts with a dormancy state in which the PDCCH is not monitored based on the DRX configuration information.

15. (canceled)
